(19) United States
(12) Patent Application Publication
(10) Pub. No.: US 2024/0118941 A1
(43) Pub. Date: Apr. 11, 2024

(54) LOAD BALANCING IN A SYSTEM

(71) Applicant: Telefonaktiebolaget LM Ericsson (publ), Stockholm (SE)

(72) Inventors: Balázs Peter GERÖ, Budapest (HU); András KERN, Budapest (HU)

(21) Appl. No.: 18/256,675

(22) PCT Filed: Dec. 14, 2020
(86) PCT No.: PCT/EP2020/086025

§ 371 Date: Jun. 9, 2023

(51) Int. Cl. G06F 9/50

(52) U.S. Cl. CPC G06F 9/5083

(57) ABSTRACT

There is provided a method performed by an entity for load balancing in a system including a function-as-a-service (FaaS) system and a container-as-a-service (CaaS) system. The method is performed in response to a change in a load balancing configuration of a plurality of software containers of the CaaS system and/or a second load balancing configuration of a plurality of software functions of the FaaS system. Each software container is associated with a respective software function. The first load balancing configuration and second load balancing configuration are coordinated such that, following the change, each execution instance of one or more of the plurality software functions is subject to the same load balancing configuration as each instance of one or more of the plurality of software containers with which the one or more of the plurality of software functions is associated.

### TECHNICAL FIELD

The disclosure relates to a method for load balancing in a system and an entity configured to operate in accordance with that method.

### BACKGROUND

In many scenarios, it is useful to balance the load in a system. Kubernetes provides load balancing between a group of containers that are configured to operate under the same Kubernetes service. In the art, this group of containers is known as a pod. On the client side, a service mesh implements load balancing via sidecar containers. The sidecar containers are deployed together in client pods towards server pods implementing the targeted Kubernetes service. The server pods, by default, reside in the same Kubernetes cluster as the client pods. A service mesh implementation can be deployed over multiple Kubernetes clusters to allow the server pods of a service instance to reside at a remote cluster.

In a technique referred to in the art as “lookaside load balancing”, the load balancing logic is implemented in a special load balancing server. In this technique, clients query the lookaside load balancer and the load balancer responds with the best server(s) to use. There also exist techniques that involve a network load balancer, whereby load balancing is based on consistent hashing. Some of these techniques use a look-up table configuration, which ensures that the positions of individual backends in the look-up table are deterministic.

However, while there are various existing techniques for load balancing, the existing techniques generally do not work well in the case of a system comprising a function-as-a-service (FaaS) system and a container-as-a-service (CaaS) system. In particular, with stand-alone container load balancing and stand-alone function execution load balancing, communication between containers of a CaaS system and functions of a FaaS system cannot be kept on the same node (or site). The main reason for this is that it is not possible to use the same database shards in functions and in containers. A database shard is a horizontal partition of data in a database. Each individual partition is referred to as a shard or database shard. Each shard is held on a separate node (or site, e.g. database server instance) to spread load.

FIG. 1 illustrates an existing system comprising a FaaS system and a Caas system in which the above-described issue can be observed. As illustrated in FIG. 1, the FaaS system comprises a load balancer (“FaaS LB”) and the CaaS system comprises a load balancer (“CaaS LB”). The load balancer of the FaaS system is configured to perform load balancing in the FaaS system and the load balancer of the CaaS system is configured to perform load balancing in the CaaS system.

In the system illustrated in FIG. 1, there are a plurality of different software functions f_{A}, f_{B} and a plurality of different execution instances of one of these software functions f_{B}, f_{B}. In the system illustrated in FIG. 1, there are also a plurality of different software containers c_{A}, c_{B} and different instances of one of these software containers c_{B}, c_{B}. The different software functions f_{A}, f_{B} are constrained to different platforms of the FaaS system (FaaS₁, FaaS₂ respectively). The plurality of software functions f_{A}, f_{B} and the different execution instances of these software functions f_{B}, f_{B} are located on different nodes (or sites). Similarly, the plurality of software containers c_{A}, c_{B} and the different instances of these software containers c_{B}, c_{B} are located on different nodes (or sites). The plurality of software functions f_{A}, f_{B} and the plurality of software containers c_{A}, c_{B} can belong to a plurality of affinity groups (c_{A}, f_{A}), (c_{B}, f_{B}).

When an external call for data enters the system illustrated in FIG. 1, the load balancers of the FaaS and CaaS systems can respectively end up placing the call for data with an execution instance of a software function and an instance of a software container that are on different nodes. For example, as illustrated in FIG. 1, the load balancer of the CaaS system may place the call for data with a software container instance c_{B} on a first node, whereas the load balancer of the FaaS system may place the call for data with a function execution instance f_{B} on a different second node. The first node comprises a first database shard (“shard₁”) and the second node comprises a second database shard (“shard₂”). The database shards cannot be shared.

As the first database shard comprises the called data, the software container instance c_{B} with which the call for data is placed and the function execution instance f_{B} with which the call for data is placed need to access the data from different nodes. As illustrated in FIG. 1, the software container instance with which the call for data is placed can access the data locally, whereas the function execution instance with which the call for data is placed needs to access the data remotely. This increases the bandwidth requirements of the system and also increases the latency in the system. It is also not possible for functions to constrain the execution of subsequent functions to nodes that host a given database shard in accordance with how containers manage database shards. In general, data that is generated by containerized code and that is accessed by function code cannot typically be retrieved from a local cache.

### SUMMARY

It is thus an object of the disclosure to obviate or eliminate at least some of the above-described disadvantages associated with existing techniques.

Therefore, according to an aspect of the disclosure, there is provided a method performed by an entity for load balancing in a system comprising a function-as-a-service (FaaS) system and a container-as-a-service (CaaS) system. The FaaS system runs a plurality of software functions, the CaaS system runs a plurality of software containers, and each software container of the plurality of software containers is associated with a respective software function of the plurality of software functions. The method is performed in response to a change in a first load balancing configuration of the plurality of software containers and/or a second load balancing configuration of the plurality of software functions. The method comprises coordinating the first load balancing configuration and the second load balancing configuration such that, following the change, each execution instance of one or more of the plurality software functions is subject to the same load balancing configuration as each instance of one or more of the plurality of software containers with which the one or more of the plurality of software functions is associated.

In this way, a consistent load balancing is applied to both software function execution instances and software container instances across the system. This improves the operation of the system in a variety of ways. For example, the bandwidth requirements of the system can be reduced and/or latency in the system can be reduced. This is particularly advantageous where software is deployed partly as containers and partly as functions.

In some embodiments, each software container may be associated with a respective software function by having one or more common constraints.

In some embodiments, the one or more common constraints comprises a constraint that the software container may be co-located with the respective software function.

In some embodiments, the software container and the respective software function may be co-located at the same node or site.

In some embodiments, the one or more common constraints may comprise a constraint that the software container uses the same database shard as the respective software function. In this way, the same load balancing is employed across database shards used by software functions and containers that are associated with each other (e.g. in the same affinity group). A common load balancing entry point to the data shards is thus used regardless of whether the entry point is called from the software functions or containers. In this way, the bandwidth requirements of the system are reduced and latency of the system is also reduced.

In some embodiments, the method may comprise acquiring information indicative of the association of each software container of the plurality of software containers with the respective software function of the plurality of software functions.

In some embodiments, in response to a change in the first load balancing configuration, coordinating the first load balancing configuration and the second load balancing configuration may comprise generating an updated second load balancing configuration such that, following the change, each execution instance of one or more of the plurality of software functions is subject to the same load balancing configuration as each instance of one or more of the plurality of software containers with which the one or more of the plurality of software functions is associated.

In some embodiments, the first load balancing configuration may comprise a plurality of identifiers, each of which identifies a software container of the plurality of software containers. In some of these embodiments, generating the updated second load balancing configuration may comprise, for each of the plurality of software containers, replacing the identifier that identifies the software container with an identifier that identifies the software function with which the software container is associated.

In some embodiments, generating the updated second load balancing configuration may comprise creating a copy of the first load balancing configuration, wherein the identifier that identifies the software container may be replaced in the copy of the first load balancing configuration.

In some embodiments, the method may comprise, for each of the plurality of software functions, acquiring the identifier that identifies the software function.

In some embodiments, the method may comprise providing the updated second load balancing configuration to a FaaS node, wherein the FaaS node may be a node that is configured to perform load balancing in the FaaS system.

In some embodiments, the method may comprise acquiring the first load balancing configuration from a CaaS node, wherein the CaaS node may be a node that is configured to perform load balancing in the CaaS system.

In some embodiments, acquiring the first load balancing configuration from the CaaS node may comprise reading the first load balancing configuration from the CaaS node or receiving the first load balancing configuration from the CaaS node in response to a request for the first load balancing configuration.

In some embodiments, in response to a change in the second load balancing configuration, coordinating the first load balancing configuration and the second load balancing configuration may comprise generating an updated first load balancing configuration such that, following the change, each execution instance of one or more of the plurality of software function is subject to the same load balancing configuration as each instance of one or more of the plurality of software containers with which the one or more of the plurality of software functions is associated.

In some embodiments, the second load balancing configuration may comprise a plurality of identifiers, each of which identifies a software function of the plurality of software functions and generating the updated first load balancing configuration may comprise, for each of the plurality of software functions, replacing the identifier that identifies the software function with an identifier that identifies the software container with which the software function is associated.

In some embodiments, generating the updated first load balancing configuration may comprise creating a copy of the second load balancing configuration, wherein the identifier that identifies the software function is replaced in the copy of the second load balancing configuration.

In some embodiments, the method may comprise, for each of the plurality of software containers, acquiring the identifier that identifies the software container.

In some embodiments, the method may comprise providing the updated first load balancing configuration to a CaaS node, wherein the CaaS node is a node that is configured to perform load balancing in the CaaS system.

In some embodiments, the method may comprise acquiring the second load balancing configuration from a FaaS node, wherein the FaaS node may be a node that is configured to perform load balancing in the FaaS system.

In some embodiments, acquiring the second load balancing configuration from the FaaS node may comprise reading the second load balancing configuration from the FaaS node or receiving the second load balancing configuration from the FaaS node in response to a request for the second load balancing configuration.

In some embodiments, the first load balancing configuration and/or the second load balancing configuration may be stored in a look-up table.

In some embodiments, the software may be a service or an application.

According to another aspect of the disclosure, there is provided an entity configured to operate in accordance with the method described earlier. The entity thus provides the advantages described earlier. In some embodiments, the entity may comprise processing circuitry configured to operate in accordance with the method described earlier. In some embodiments, the entity may comprise at least one memory for storing instructions which, when executed by the processing circuitry, cause the entity to operate in accordance with the method described earlier.

According to another aspect of the disclosure, there is provided a computer program comprising instructions which, when executed by processing circuitry, cause the processing circuitry to perform the method described earlier. The computer program thus provides the advantages described earlier.

According to another aspect of the disclosure, there is provided a computer program product, embodied on a non-transitory machine-readable medium, comprising instructions which are executable by processing circuitry to cause the processing circuitry to perform the method described earlier. The computer program product thus provides the advantages described earlier.

Therefore, advantageous techniques for load balancing in a system are provided.

### BRIEF DESCRIPTION OF THE DRAWINGS

For a better understanding of the techniques, and to show how they may be put into effect, reference will now be made, by way of example, to the accompanying drawings, in which:

FIG. 1 is a schematic illustrating an existing system;

FIG. 2 is a schematic illustrating a system according to an embodiment;

FIG. 3 is a block diagram illustrating an entity according to an embodiment;

FIG. 4 is a flowchart illustrating a method performed by an entity according to an embodiment;

FIG. 5 is a flowchart illustrating a method performed by an entity according to an embodiment;

FIG. 6 is a flowchart illustrating a method performed by an entity according to an embodiment;

FIG. 7 is a schematic illustrating a system according to an embodiment; and

FIG. 8 is a block diagram illustrating an entity according to an embodiment.

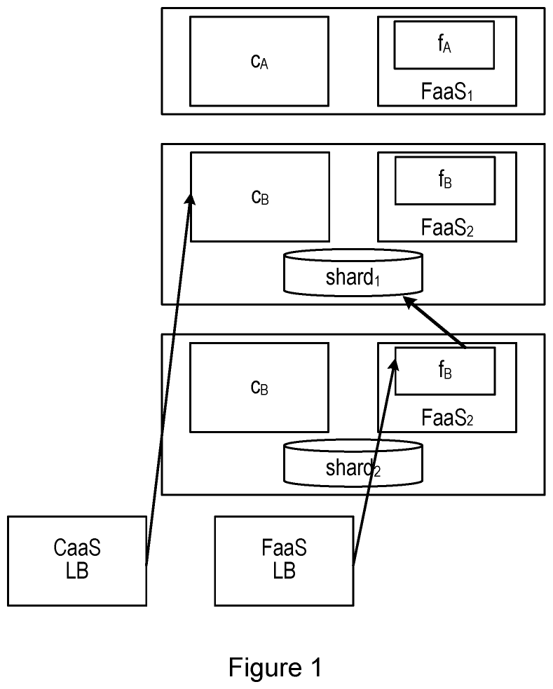

### DETAILED DESCRIPTION

As mentioned earlier, advantageous techniques for load balancing in a system are described herein. The system referred to herein comprises a function-as-a-service (FaaS) system and a container-as-a-service system (CaaS). Generally, a FaaS system is a system that provides a platform to allow users to develop, run, and/or manage software functionalities without the complexity of building and/or maintaining the infrastructure in order to do so. On the other hand, a CaaS system is a container-based virtualization system in which container engines, orchestration and/or underlying compute resources are delivered to users as a service from a cloud provider.

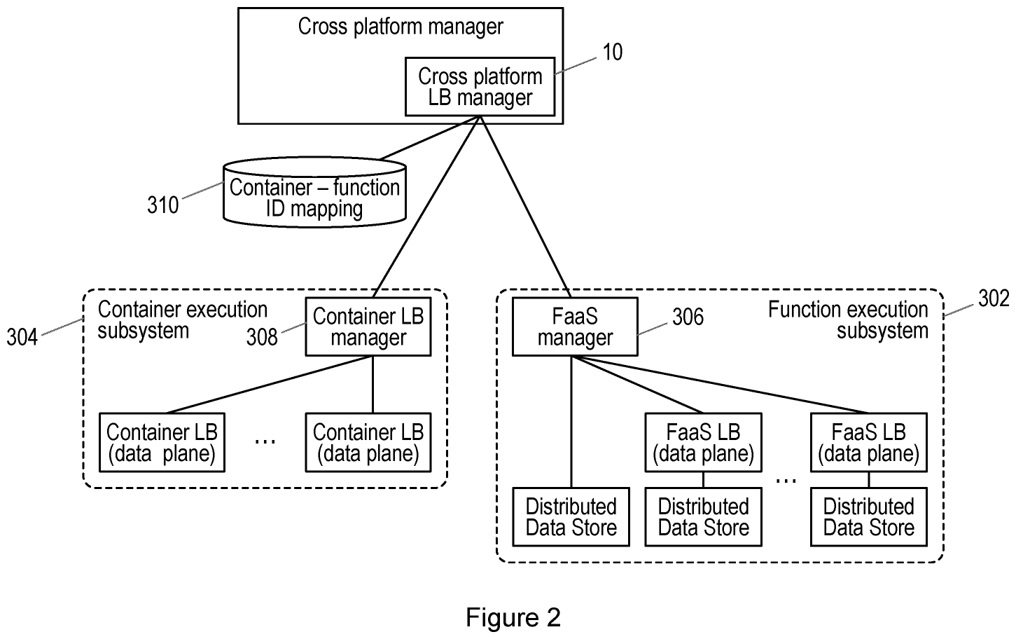

FIG. 2 illustrates a system comprising a FaaS system (or subsystem) 302 and a CaaS system (or subsystem) 304 in accordance with an embodiment. The FaaS system 302 runs (or executes) a plurality of functions (not illustrated in FIG. 2). The CaaS system 304 runs (or executes) a plurality of containers (not illustrated in FIG. 2). Herein, each container of the plurality of containers is associated with (or mapped to) a respective function of the plurality of functions. Functions are units of software and thus may also be referred to herein as software functions. Similarly, containers are units of software and thus may also be referred to herein as software containers.

As illustrated in FIG. 2, in some embodiments, the FaaS system 302 can comprise a FaaS node (or FaaS manager node) 306 that is configured to perform load balancing in the FaaS system 302. As also illustrated in FIG. 2, in some embodiments, the FaaS system 302 can comprise a plurality of (e.g. distributed) data stores and/or a plurality of FaaS load balancers (LBs). A data plane of the FaaS system 302 can comprise the plurality of FaaS load balancers. The FaaS node 306 can communicate with one or more of the plurality of data stores and/or one or more of the plurality of FaaS load balancers in order to perform load balancing in the FaaS system 302.

As illustrated in FIG. 2, in some embodiments, the CaaS system 304 can comprise a CaaS node (or CaaS manager node) 308 that is configured to perform load balancing in the CaaS system 304. As also illustrated in FIG. 2, in some embodiments, the CaaS system 304 can comprise a plurality of CaaS load balancers (LBs). A data plane of the CaaS system 304 can comprise the plurality of CaaS load balancers. The CaaS node 308 can communicate with one or more of the plurality of CaaS load balancers in order to perform load balancing in the CaaS system 304. In some embodiments, the FaaS system 302 can be configured to use the same load balancing data plane and/or configuration as the CaaS system 304.

In some embodiments, the CaaS system 304 may be a Kubernetes (K8s) system. A K8s system is an open-source container-orchestration system. In some of these embodiments, the CaaS node 308 can be a K8s node. The data plane of the CaaS system can be a data plane configured by this K8s node and optionally also one or more external K8s load balancers. In some embodiments, the extent of the FaaS system 302 may cover the extent of the K8s system. In other embodiments, the CaaS system 304 may be a service mesh. In some of these embodiments, the CaaS node 308 can be a service mesh node. The data plane of the CaaS system can be a data plane configured by one or more envoy side-car containers. In some embodiments, the extent of the FaaS system 302 may cover the extent of the service mesh.

The system illustrated in FIG. 2 comprises an entity 10. The technique described herein is implemented by this entity 10. The entity 10 may also be referred to herein as a load balancing (LB) manager, or a cross system (or platform) LB manager. In some embodiments, another entity may comprise this entity 10. For example, as illustrated in FIG. 2, a cross system (or platform) manager may comprise the entity 10 according to some embodiments. However, in other embodiments (not illustrated), the entity 10 may be a standalone entity. The entity 10 can be an entity that is common to the FaaS system 302 and the CaaS system 304. The entity 10 can be configured to manage the load balancing configuration of the FaaS system 302 and/or the load balancing configuration of the CaaS system 304.

As illustrated in FIG. 2, in some embodiments, the system may comprise a memory 310. In the system illustrated in FIG. 2, the memory 310 is illustrated as separate to the entity 10. However, in other embodiments, the entity 10 may alternatively or in addition comprise such a memory 310. As mentioned earlier, each software container of the plurality of software containers is associated with (or mapped to) a respective software function of the plurality of software functions. In some embodiments, the memory 310 can be configured to store this association (or mapping). In some embodiments, for at least one software container, the association (or mapping) may comprise an association (or mapping) between an identifier (ID) that identifies the at least one software container and an identifier (ID) that identifies a respective software function.

Herein, any references to a software function will be understood to mean the software function itself or an instance of the software function, i.e. a software function instance. Similarly, any references to a software container herein will be understood to mean the software container itself or an instance of the software container, i.e. a software container instance. Also, any reference to software herein will be understood to mean an application, a service, and/or any other type of software. In some embodiments, software (which can be packaged as containers and/or functions) can carry the same session identifier (ID) in the containerized and function codes. This session ID may be configured as the single input for the load balancing described herein according to some embodiments.

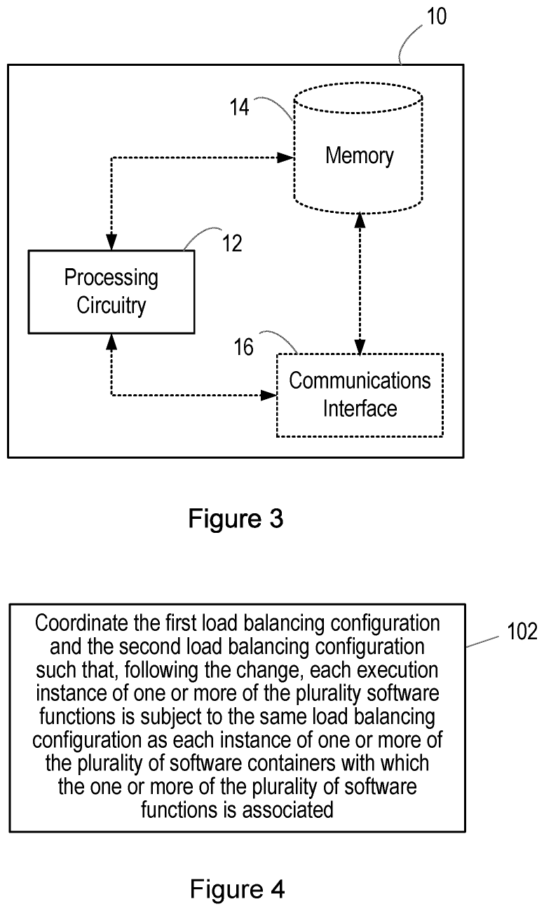

FIG. 3 illustrates the entity 10 in accordance with an embodiment. The entity 10 is for load balancing in a system (such as that described earlier with reference to FIG. 2) comprising a FaaS system 302 and a CaaS system 304. As mentioned earlier, the FaaS system runs a plurality of software functions, the CaaS system runs a plurality of software containers, and each software container of the plurality of software containers is associated with a respective software function of the plurality of software functions. The entity 10 may, for example, be a physical machine (e.g. a server) or a virtual machine (VM).

As illustrated in FIG. 3, the entity 10 comprises processing circuitry (or logic) 12. The processing circuitry 12 controls the operation of the entity 10 and can implement the method described herein in respect of the entity 10. The processing circuitry 12 can be configured or programmed to control the entity 10 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the entity 10. In some embodiments, the processing circuitry 12 can be configured to run software to perform the method described herein in respect of the entity 10. The software may be containerised according to some embodiments. In some embodiments, the software may be a software update for the entity 10. Thus, in some embodiments, the processing circuitry 12 may be configured to run a container to perform the method described herein in respect of the entity 10.

Briefly, the processing circuitry 12 of the entity 10 is configured to operate in response to a change in a first load balancing configuration of the plurality of software containers and/or a second load balancing configuration of the plurality of software functions. The processing circuitry 12 of the entity 10 is configured to coordinate the first load balancing configuration and the second load balancing configuration such that, following the change, each execution instance of one or more of the plurality software functions is subject to the same load balancing configuration as each instance of one or more of the plurality of software containers with which the one or more of the plurality of software functions is associated.

As illustrated in FIG. 3, in some embodiments, the entity 10 may optionally comprise a memory 14. The memory 14 of the entity 10 can comprise a volatile memory or a non-volatile memory. In some embodiments, the memory 14 of the entity 10 may comprise a non-transitory media. Examples of the memory 14 of the entity 10 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the entity 10 can be connected to the memory 14 of the entity 10. In some embodiments, the memory 14 of the entity 10 may be for storing program code or instructions which, when executed by the processing circuitry 12 of the entity 10, cause the entity 10 to operate in the manner described herein in respect of the entity 10. For example, in some embodiments, the memory 14 of the entity 10 may be configured to store program code or instructions that can be executed by the processing circuitry 12 of the entity 10 to cause the entity 10 to operate in accordance with the method described herein in respect of the entity 10. Alternatively or in addition, the memory 14 of the entity 10 can be configured to store any information, data, messages, requests, responses, indications, notifications, signals, or similar, that are described herein. The processing circuitry 12 of the entity 10 may be configured to control the memory 14 of the entity 10 to store information, data, messages, requests, responses, indications, notifications, signals, or similar, that are described herein.

In some embodiments, as illustrated in FIG. 3, the entity 10 may optionally comprise a communications interface 16. The communications interface 16 of the entity 10 can be connected to the processing circuitry 12 of the entity 10 and/or the memory 14 of entity 10. The communications interface 16 of the entity 10 may be operable to allow the processing circuitry 12 of the entity 10 to communicate with the memory 14 of the entity 10 and/or vice versa. Similarly, the communications interface 16 of the entity 10 may be operable to allow the processing circuitry 12 of the entity 10 to communicate with at least one other entity described herein, such as at least one entity/node of the FaaS system and/or at least one entity/node of the CaaS system. The communications interface 16 of the entity 10 can be configured to transmit and/or receive information, data, messages, requests, responses, indications, notifications, signals, or similar, that are described herein. In some embodiments, the processing circuitry 12 of the entity 10 may be configured to control the communications interface 16 of the entity 10 to transmit and/or receive information, data, messages, requests, responses, indications, notifications, signals, or similar, that are described herein.

Although the entity 10 is illustrated in FIG. 3 as comprising a single memory 14, it will be appreciated that the entity 10 may comprise at least one memory (i.e. a single memory or a plurality of memories) 14 that operate in the manner described herein. Similarly, although the entity 10 is illustrated in FIG. 3 as comprising a single communications interface 16, it will be appreciated that the entity 10 may comprise at least one communications interface (i.e. a single communications interface or a plurality of communications interface) 16 that operate in the manner described herein. It will also be appreciated that FIG. 3 only shows the components required to illustrate an embodiment of the entity 10 and, in practical implementations, the entity 10 may comprise additional or alternative components to those shown.

FIG. 4 is a flowchart illustrating a method performed by the entity 10 in accordance with an embodiment. The method is for load balancing in a system (such as that described earlier with reference to FIG. 2) comprising a FaaS system 302 and a CaaS system 304. As mentioned earlier, the FaaS system runs a plurality of software functions and the CaaS system runs a plurality of software containers. The entity 10 described earlier with reference to FIG. 3 can be configured to operate in accordance with the method of FIG. 4. The method can be performed by or under the control of the processing circuitry 12 of the entity 10. The method is performed in response to a change in a first load balancing configuration (or policy) of the plurality of software containers and/or a second load balancing configuration (or policy) of the plurality of software functions.

As mentioned earlier, each software container of the plurality of software containers is associated with a respective software function of the plurality of software functions. For example, in some embodiments, each software container can be associated with a respective software function by having one or more common constraints. In some embodiments, the one or more common constraints comprises a constraint that the software container can be co-located with the respective software function. In some embodiments, the software container and the respective software function may be co-located at the same node or site. In these embodiments, the one or more common constraints can comprise a constraint that the software container uses the same database shard as the respective software function. However, although some examples have been provided for the one or more common constraints by which a software container may be associated with a respective software function, other constraints (and any combination of constraints) are also possible.

Herein, when a software container of the plurality of software containers is associated with a respective software function of the plurality of software functions, the software container and the respective software function can be said to be in the same (e.g. affinity) group. In some embodiments, more than one software container (e.g. a set of software containers) may be associated (or in an affinity group) with a respective software function. In some embodiments, it may be a prerequisite that the CaaS system 304 ensures that each of the plurality of software functions are deployed and optionally also co-located with one or more of the (e.g. backend service) software containers.

As illustrated at block 102 of FIG. 4, the first load balancing configuration and the second load balancing configuration are coordinated such that, following the change in the first load balancing configuration and/or the second load balancing configuration, each execution instance of one or more of the plurality software functions is subject to the same load balancing configuration as each instance of one or more of the plurality of software containers with which the one or more of the plurality of software functions is associated. More specifically, according to some embodiments, the processing circuitry 12 of the entity can coordinate the first load balancing configuration and the second load balancing 10 configuration in this way. The first load balancing configuration referred to herein and/or the second load balancing configuration referred to herein can be stored in any form, such as in a look-up table or any other form.

On the one hand, in some embodiments, in response to a change in the first load balancing configuration, coordinating the first load balancing configuration and the second load balancing configuration may comprise generating an updated second load balancing configuration such that, following the change, each execution instance of one or more of the plurality of software functions is subject to the same load balancing configuration as each instance of one or more of the plurality of software containers with which the one or more of the plurality of software functions is associated. More specifically, according to some embodiments, the processing circuitry 12 of the entity 10 can generate the updated second load balancing configuration.

Although not illustrated in FIG. 4, in some embodiments, the method may comprise acquiring the first load balancing configuration from the CaaS node 308, which is the node that is configured to perform load balancing in the CaaS system 304. More specifically, the processing circuitry 12 of the entity 10 can acquire the first load balancing configuration from the CaaS node 308 according to some embodiments. In some embodiments, acquiring the first load balancing configuration from the CaaS node 308 may comprise reading the first load balancing configuration from the CaaS node 308. In other embodiments, acquiring the first load balancing configuration from the CaaS node 308 may comprise receiving the first load balancing configuration from the CaaS node 308 (e.g. via a communications interface 16 of the entity 10) in response to a request for the first load balancing configuration. Thus, in some embodiments, the method may comprise transmitting a request for the first load balancing configuration towards the CaaS node 308.

In some embodiments, the first load balancing configuration may comprise a plurality of identifiers, each of which identifies a software container of the plurality of software containers. In these embodiments, generating the updated second load balancing configuration can comprise, for each of the plurality of software containers, replacing the identifier that identifies the software container with an identifier that identifies the software function with which the software container is associated. In this way, generic (e.g. backend server) CaaS identifiers in the first load balancing configuration can be adapted to FaaS platform specific (e.g. backend server) identifiers. In some of these embodiments, generating the updated second load balancing configuration may comprise creating a copy of the first load balancing configuration and, in these embodiments, the identifier that identifies the software container is replaced in the copy of the first load balancing configuration.

In some embodiments, information indicative of the association of each software container of the plurality of software containers with the respective software function of the plurality of software functions may be acquired (e.g. from the memory 14 of the entity 10, or another memory 310). More specifically, the processing circuitry 12 of the entity 10 can be configured to acquire the information indicative of the association according to some embodiments. In some embodiments involving identifiers, for each of the plurality of software functions, the identifier that identifies the software function may be acquired (e.g. from the memory 14 of the entity 10, or another memory 310). More specifically, the processing circuitry 12 of the entity 10 can be configured to, for each of the plurality of software functions, acquire the identifier that identifies the software function according to some embodiments.

Although not illustrated in FIG. 4, in some embodiments, the method may comprise providing the updated second load balancing configuration to the FaaS node 306, which is the node that is configured to perform load balancing in the FaaS system 302. More specifically, the processing circuitry 12 of the entity 10 can be configured to provide the updated second load balancing configuration to the FaaS node 306 according to some embodiments. For example, the updated second load balancing configuration may be provided to the FaaS node 306 by making the updated second load balancing configuration accessible to the FaaS node 306, such that the FaaS node 306 can read the updated second load balancing configuration from the entity 10. In other embodiments, the updated second load balancing configuration may be provided to the FaaS node 306 by transmitting, or uploading, the updated second load balancing configuration to the FaaS node 306.

The FaaS node 306 can be configured to balance the load in the FaaS system according to the updated second load balancing configuration. Thus, the same load balancing configuration can be configured in both the FaaS node 306 and the CaaS node 308. In an embodiment where the load balancing configuration is a load balancing look-up table, the same size load balancing look-up table may be configured in both the FaaS node 306 and the CaaS node 308. In some embodiments, the same hash algorithm may be configured in both the FaaS node 306 and the CaaS node 308.

On the other hand, in some embodiments, in response to a change in the second load balancing configuration, coordinating the first load balancing configuration and the second load balancing configuration may comprise generating an updated first load balancing configuration such that, following the change, each execution instance of one or more of the plurality of software function is subject to the same load balancing configuration as each instance of one or more of the plurality of software containers with which the one or more of the plurality of software functions is associated.

Although not illustrated in FIG. 4, in some embodiments, the method may comprise acquiring the second load balancing configuration from the FaaS node 306, which is the node that is configured to perform load balancing in the FaaS system 302. More specifically, the processing circuitry 12 of the entity 10 can acquire the second load balancing configuration from the FaaS node 306 according to some embodiments. In some embodiments, acquiring the second load balancing configuration from the FaaS node 306 may comprise reading the second load balancing configuration from the FaaS node 306. In other embodiments, acquiring the second load balancing configuration from the FaaS node 306 may comprise receiving the second load balancing configuration from the FaaS node 306 (e.g. via a communications interface 16 of the entity 10) in response to a request for the second load balancing configuration. Thus, in some embodiments, the method may comprise transmitting a request for the second load balancing configuration towards the FaaS node 306.

In some embodiments, the second load balancing configuration may comprise a plurality of identifiers, each of which identifies a software function of the plurality of software functions. In these embodiments, generating the updated first load balancing configuration may comprise, for each of the plurality of software functions, replacing the identifier that identifies the software function with an identifier that identifies the software container with which the software function is associated. In this way, generic (e.g. backend server) FaaS identifiers in the second load balancing configuration can be adapted to CaaS platform specific (e.g. backend server) identifiers. In some of these embodiments, generating the updated first load balancing configuration may comprise creating a copy of the second load balancing configuration and, in these embodiments, the identifier that identifies the software function is replaced in the copy of the second load balancing configuration.

In some embodiments involving identifiers, for each of the plurality of software containers, the identifier that identifies the software container may be acquired (e.g. from the memory 14 of the entity 10, or another memory 310). More specifically, the processing circuitry 12 of the entity 10 can be configured to, for each of the plurality of software containers, acquire the identifier that identifies the software container according to some embodiments.

Although not illustrated in FIG. 4, in some embodiments, the method may comprise providing the updated first load balancing configuration to the CaaS node 308, which is the node that is configured to perform load balancing in the CaaS system 304. More specifically, the processing circuitry 12 of the entity 10 can be configured to provide the updated first load balancing configuration to the CaaS node 308 according to some embodiments. For example, the updated first load balancing configuration may be provided to the CaaS node 308 by making the updated first load balancing configuration accessible to the CaaS node 308, such that the CaaS node 308 can read the updated first load balancing configuration from the entity 10. In other embodiments, the updated first load balancing configuration may be provided to the CaaS node 308 by transmitting, or uploading, the updated first load balancing configuration to the CaaS node 308.

The CaaS node 308 can be configured to balance the load in the CaaS system 304 according to the updated first load balancing configuration. Thus, the same load balancing configuration can be configured in both the FaaS node 306 and the CaaS node 308. In an embodiment where the load balancing configuration is a load balancing look-up table, the same size load balancing look-up table may be configured in both the FaaS node 306 and the CaaS node 308. In some embodiments, the same hash algorithm may be configured in both the FaaS node 306 and the CaaS node 308.

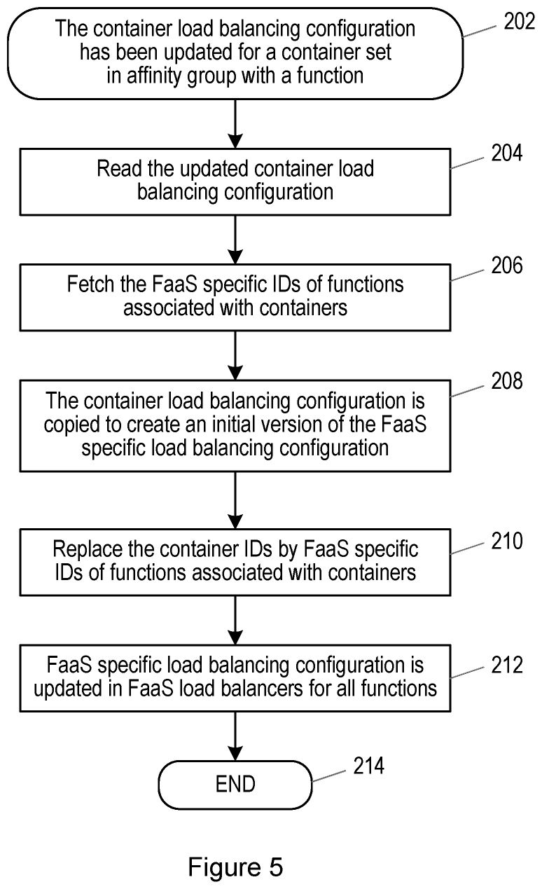

FIG. 5 is a flowchart illustrating a method performed by the entity 10 in accordance with an embodiment. The method is for load balancing in a system (such as that described earlier with reference to FIG. 2) comprising a FaaS system 302 and a CaaS system 304. As mentioned earlier, the FaaS system 302 runs a plurality of software functions and the CaaS system 304 runs a plurality of software containers. The entity 10 described earlier with reference to FIG. 3 can be configured to operate in accordance with the method of FIG. 5. The method can be performed by or under the control of the processing circuitry 12 of the entity 10. The method is performed in response to a change in a first load balancing configuration of the plurality of software containers.

As illustrated at block 202 of FIG. 5, the first load balancing configuration (e.g. stored in a look-up table) has changed (or been updated). The rest of the method is performed (e.g. invoked) in response to this change. In some embodiments, the method may be performed (or invoked) in response to a change in the first load balancing configuration for a software container (or set of software containers) associated with, or in an affinity group with, a respective software function. This may occur, for example, due to scaling out of the CaaS system 304 (e.g. a K8s scale out in the case of a K8s embodiment) as this event triggers a load balancing (re)configuration in the CaaS system 304. As a result, an updated first load balancing configuration may be installed in each of the plurality of CaaS load balancers. The method may proceed when the entity 10 is notified that the first load balancing configuration has changed.

As illustrated at block 204 of FIG. 5, in response to the change in the first load balancing configuration, the first load balancing configuration is acquired (e.g. read or received) from the CaaS node 308 that is configured to perform load balancing in the CaaS system 304. More specifically, the processing circuitry 12 of the entity 10 can acquire the first load balancing configuration from the CaaS node 308 according to some embodiments.

As illustrated at block 206 of FIG. 5, in some embodiments, information indicative of the association of each software container of the plurality of software containers with the respective software function of the plurality of software functions may be acquired (e.g. fetched, read, or received), such as from a memory of the entity 10 or any other memory 310. More specifically, the processing circuitry 12 of the entity 10 can acquire the information according to some embodiments. The information can comprise information indicative of the association between an identifier of each software container and an identifier of the respective software function. As mentioned previously, the association may be that a software container is co-located (or has any other association) with a respective software function. For each of the plurality of software functions, the identifier that identifies the respective software function may be acquired (e.g. fetched, read, or received), such as from the memory of the entity 10 or any other memory 310. More specifically, the processing circuitry 12 of the entity 10 can acquire, for each of the plurality of software functions, the identifier that identifies the respective software function according to some embodiments.

As illustrated at block 208 of FIG. 5, the first load balancing configuration is copied to create an initial version of an updated second load balancing configuration (e.g. stored in a look-up table). More specifically, the processing circuitry 12 of the entity 10 can be configured to create the copy of the first load balancing configuration according to some embodiments.

As illustrated at block 210 of FIG. 5, for each of the plurality of software containers, the identifier that identifies the software container is replaced in the copy of the first load balancing configuration with the acquired identifier that identifies the respective software function with which the software container is associated (e.g. co-located or associated in any other way). That is, the software container identifiers are each replaced with (FaaS specific) identifiers that correspond to the respective software functions that are associated (e.g. co-located or associated in any other way) with the given software containers. More specifically, the processing circuitry 12 of the entity 10 can be configured to perform the identifier replacement according to some embodiments. Thus, an updated second load balancing configuration is generated.

As illustrated at block 212 of FIG. 5, in some embodiments, the updated second load balancing configuration may be provided (e.g. transmitted or uploaded) to the FaaS node 306 that is configured to perform load balancing in the FaaS system 302. More specifically, the processing circuitry 12 of the entity 10 can be configured to provide the updated second load balancing configuration to the FaaS node 306 according to some embodiments. If there is more than one FaaS node 306 that is configured to perform load balancing in the FaaS system 302, the updated second load balancing configuration may be provided to all of these FaaS nodes 306 in some embodiments.

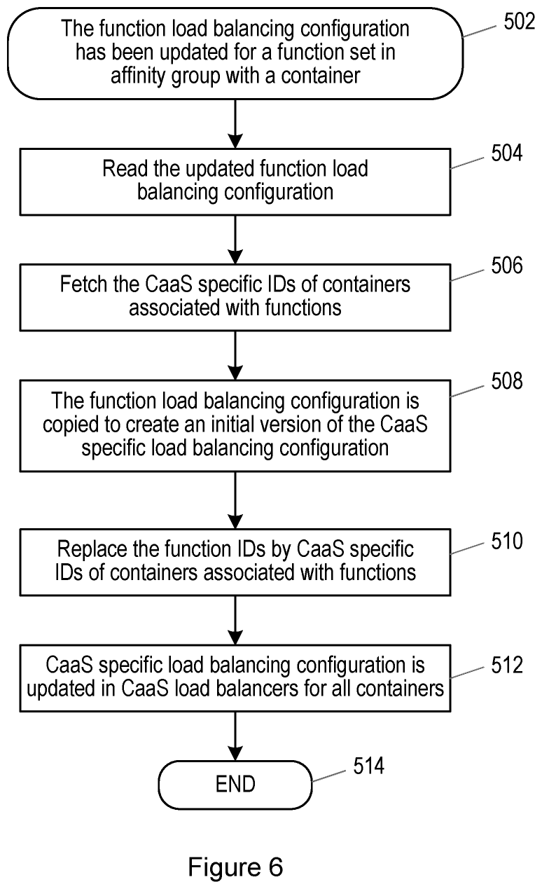

FIG. 6 is a flowchart illustrating a method performed by the entity 10 in accordance with an embodiment. The method is for load balancing in a system (such as that described earlier with reference to FIG. 2) comprising a FaaS system 302 and a CaaS system 304. As mentioned earlier, the FaaS system 302 runs a plurality of software functions and the CaaS system 304 runs a plurality of software containers. The entity 10 described earlier with reference to FIG. 3 can be configured to operate in accordance with the method of FIG. 6. The method can be performed by or under the control of the processing circuitry 12 of the entity 10. The method is performed in response to a change in a second load balancing configuration of the plurality of software functions.

As illustrated at block 502 of FIG. 6, the second load balancing configuration (e.g. stored in a look-up table) has changed (or been updated). The rest of the method is performed (e.g. invoked) in response to this change. In some embodiments, the method may be performed (or invoked) in response to a change in the second load balancing configuration for a software function (or set of software functions) associated with, or in an affinity group with, a respective software container. This may occur, for example, due to scaling out of the FaaS system 302 (e.g. a K8s scale out in the case of a K8s embodiment) as this event triggers a load balancing (re)configuration in the FaaS system 302. As a result, an updated second load balancing configuration may be installed in each of the plurality of FaaS load balancers. The method may proceed when the entity 10 is notified that the second load balancing configuration has changed.

As illustrated at block 504 of FIG. 6, in response to the change in the second load balancing configuration, the second load balancing configuration is acquired (e.g. read or received) from the FaaS node 306 that is configured to perform load balancing in the FaaS system 306. More specifically, the processing circuitry 12 of the entity 10 can acquire the second load balancing configuration from the FaaS node 306 according to some embodiments.

As illustrated at block 506 of FIG. 6, in some embodiments, information indicative of the association of each software container of the plurality of software containers with the respective software function of the plurality of software functions may be acquired (e.g. fetched, read, or received), such as from a memory of the entity 10 or any other memory 310. More specifically, the processing circuitry 12 of the entity 10 can acquire the information according to some embodiments. The information can comprise information indicative of the association between an identifier of each software container and an identifier of the respective software function. As mentioned previously, the association may be that a software container is co-located (or has any other association) with a respective software function. For each of the plurality of software functions, the identifier that identifies the respective software function may be acquired (e.g. fetched, read, or received), such as from the memory of the entity 10 or any other memory 310. More specifically, the processing circuitry 12 of the entity 10 can acquire, for each of the plurality of software functions, the identifier that identifies the respective software function according to some embodiments.

As illustrated at block 508 of FIG. 6, the second load balancing configuration is copied to create an initial version of an updated first load balancing configuration (e.g. stored in a look-up table). More specifically, the processing circuitry 12 of the entity 10 can be configured to create the copy of the second load balancing configuration according to some embodiments.

As illustrated at block 510 of FIG. 6, for each of the plurality of software functions, the identifier that identifies the software function is replaced in the copy of the second load balancing configuration with the acquired identifier that identifies the respective software container with which the software function is associated (e.g. co-located or associated in any other way). That is, the software function identifiers are each replaced with (CaaS specific) identifiers that correspond to the respective software containers that are associated (e.g. co-located or associated in any other way) with the given software functions. More specifically, the processing circuitry 12 of the entity 10 can be configured to perform the identifier replacement according to some embodiments. Thus, an updated first load balancing configuration is generated.

As illustrated at block 512 of FIG. 6, in some embodiments, the updated first load balancing configuration may be provided (e.g. transmitted or uploaded) to the CaaS node 308 that is configured to perform load balancing in the CaaS system 304. More specifically, the processing circuitry 12 of the entity 10 can be configured to provide the updated first load balancing configuration to the CaaS node 308 according to some embodiments. If there is more than one CaaS node 308 that is configured to perform load balancing in the CaaS system 304, the updated first load balancing configuration may be provided to all of these CaaS nodes 308 in some embodiments.

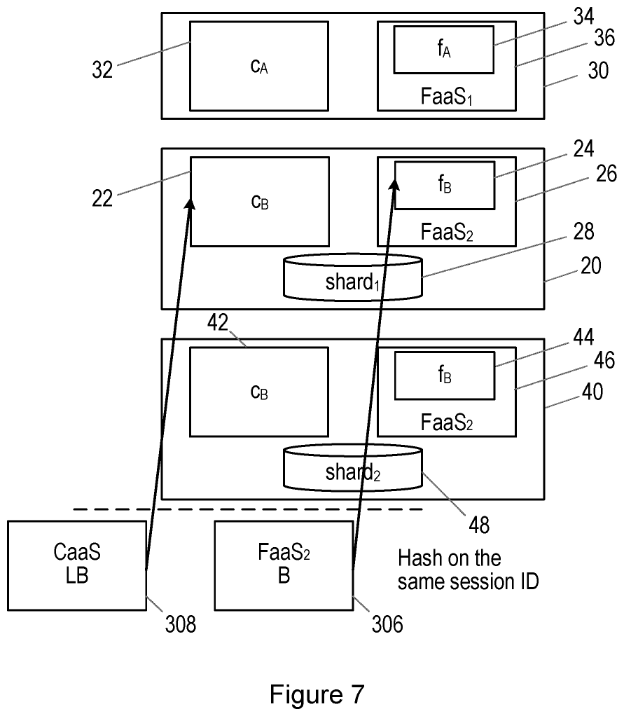

FIG. 7 illustrates a system comprising a FaaS system and a CaaS system in which the above-described technique is implemented according to an embodiment. As illustrated in FIG. 7, the FaaS system comprises a load balancer (“FaaS LB”) 306 and the CaaS system comprises a load balancer (“CaaS LB”) 308. The FaaS load balancer 306 is configured to perform load balancing in the FaaS system and the CaaS load balancer 308 is configured to perform load balancing in the CaaS system.

In the system illustrated in FIG. 7, there are a plurality of different software functions 24, 34 (f_{A}, f_{B}) and a plurality of different execution instances of one of these software functions 24, 44 (f_{B}, f_{B}). In the system illustrated in FIG. 7, there are also a plurality of different software containers 22, 32 (c_{A}, c_{B}) and different instances of one of these software containers 22, 42 (c_{B}, c_{B}). In the embodiment illustrated in FIG. 7, different software functions (f_{A}, f_{B}) are constrained to different platforms 26, 36, 46 of the FaaS system (FaaS₁, FaaS₂ respectively). It will be appreciated that the FaaS system of 46 need not be the same platform as that of 26. Any suitable FaaS platform may be used. The plurality of software functions 24, 34 (f_{A}, f_{B}) and the different execution instances of these software functions 24, 44 (f_{B}, f_{B}) are located on different nodes (or sites). Similarly, the plurality of software containers 22, 32 (c_{A}, c_{B}) and the different instances of these software containers 22, 42 (c_{B}, c_{B}) are located on a plurality of nodes (or sites) 20, 30, 40. One or more of the nodes (or sites) may comprise a database shard 28, 48. In the embodiment illustrated in FIG. 7, a first node 20 comprises a first database shard (“shard₁”) 28 and a second node 40 comprises a second database shard (“shard₂”) 48.

Although an example is shown for the purpose of this illustrated implementation of the above-described technique, it will be understood that any other number of functions, function execution instances, containers, container instances, platforms, nodes (or sites) and/or database shards is also possible in other implementations.

In the embodiment illustrated in FIG. 7, the plurality of functions 24, 34 and the plurality of containers 22, 32 belong to a plurality of affinity groups (c_{A}, f_{A}), (c_{B}, f_{B}). More specifically, each software container of the plurality of software containers 22, 32 is associated with a respective software function of the plurality of software functions 24, 34. For example, each software container 22, 32 can be associated with a respective software function 24, 34 by having one or more common constraints. In the embodiment illustrated in FIG. 7, for at least some of the software containers, the one or more common constraints can comprise a constraint that the software container 22 and the respective software function 24 are co-located on the same node (or site) 20, and a constraint that the software container 22 uses the same database shard 28 as the respective software function 24.

As described earlier, in response to a change in a first load balancing configuration of the plurality of software containers 22, 32 and/or a second load balancing configuration of the plurality of software functions 24, 34, the first load balancing configuration and the second load balancing configuration are coordinated such that, following the change, each execution instance of one or more of the plurality software functions 24, 44 is subject to the same load balancing configuration as each instance of one or more of the plurality of software containers 22, 42 with which the one or more of the plurality of software functions is associated. In this way, when an external call for data enters the system illustrated in FIG. 7, there is a coordination between the FaaS system and the CaaS system. Specifically, in view of the fact that each execution instance of one or more of the plurality software functions 24, 44 is subject to the same load balancing configuration as each instance of one or more of the plurality of software containers 22, 42 with which the one or more of the plurality of software functions is associated, the FaaS load balancer 306 and the CaaS load balancer 308 place the call for data with a software function execution instance 24 and a software container instance 22 that are on the same node (or site) 20 and that use the same database shard 28. This database shard 28 comprises the called data and is co-located at the same node (or site) 20 as the software function execution instance 24 and the software container instance 22 with which the call for data is placed. Thus, the software function execution instance 24 and the software container instance 22 with which the call for data is placed both access the data locally. In this way, the bandwidth requirements of the system are reduced and the latency in the system is also reduced.

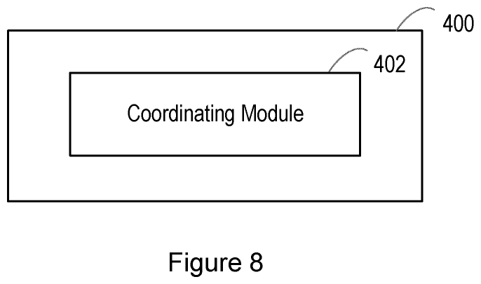

FIG. 8 is a block diagram illustrating an entity 400 in accordance with an embodiment. The entity 400 can be for load balancing in a system comprising a FaaS system and a CaaS. The FaaS system runs a plurality of software functions, the CaaS system runs a plurality of software containers, and each software container of the plurality of software containers is associated with a respective software function of the plurality of software functions. The entity 400 can operate in response to a change in a first load balancing configuration of the plurality of software containers and/or a second load balancing configuration of the plurality of software functions. The entity 400 comprises a coordinating module 402 configured to coordinate the first load balancing configuration and the second load balancing configuration such that, following the change, each execution instance of one or more of the plurality software functions is subject to the same load balancing configuration as each instance of one or more of the plurality of software containers with which the one or more of the plurality of software functions is associated. The entity 400 may operate in the manner described herein.

There is also provided a computer program comprising instructions which, when executed by processing circuitry (such as the processing circuitry 12 of the entity 10 described earlier), cause the processing circuitry to perform at least part of the method described herein. There is provided a computer program product, embodied on a non-transitory machine-readable medium, comprising instructions which are executable by processing circuitry (such as the processing circuitry 12 of the entity 10 described earlier) to cause the processing circuitry to perform at least part of the method described herein. There is provided a computer program product comprising a carrier containing instructions for causing processing circuitry (such as the processing circuitry 12 of the entity 10 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the entity functionality described herein can be performed by hardware. Thus, in some embodiments, the entity 10 described herein can be a hardware entity. However, it will also be understood that optionally at least part or all of the entity functionality described herein can be virtualized. For example, the functions performed by the entity 10 described herein can be implemented in software running on generic hardware that is configured to orchestrate the entity functionality. Thus, in some embodiments, the entity 10 described herein can be a virtual entity. In some embodiments, at least part or all of the entity functionality described herein may be performed in a network enabled cloud. The entity functionality described herein may all be at the same location or at least some of the entity functionality may be distributed.

It will be understood that at least some or all of the method steps described herein can be automated in some embodiments. That is, in some embodiments, at least some or all of the method steps described herein can be performed automatically.

Thus, in the manner described herein, there is advantageously provided a technique for load balancing in a system. More specifically, the technique described herein enables the coordination of load balancing in a CaaS system and load balancing in a FaaS system. The advantageous technique can be implemented (e.g. by the entity 10 described herein) on top of existing container and function execution environments.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method performed by an entity for load balancing in a system comprising a function-as-a-service (FaaS) system and a container-as-a-service, CaaS, (CaaS) system, wherein the FaaS system runs a plurality of software functions, the CaaS system runs a plurality of software containers, and each software container of the plurality of software containers is associated with a respective software function of the plurality of software functions, wherein the method comprises:
in response to a change in a first load balancing configuration of the plurality of software containers and/or a second load balancing configuration of the plurality of software functions:
coordinating the first load balancing configuration and the second load balancing configuration such that, following the change, each execution instance of one or more of the plurality software functions is subject to the same load balancing configuration as each instance of one or more of the plurality of software containers with which the one or more of the plurality of software functions is associated.

2. The method as claimed in claim 1, wherein:
each software container is associated with a respective software function by having one or more common constraints.

3. The method as claimed in claim 2, wherein:
the one or more common constraints comprises a constraint that the software container is co-located with the respective software function.

4. The method as claimed in claim 3, wherein:
the software container and the respective software function are co-located at the same node or site.

5. The method as claimed in claim 2, wherein:
the one or more common constraints comprises a constraint that the software container uses the same database shard as the respective software function.

6. The method as claimed in claim 1, the method comprising:
acquiring information indicative of the association of each software container of the plurality of software containers with the respective software function of the plurality of software functions.

7. The method as claimed in claim 1, wherein:
in response to a change in the first load balancing configuration, coordinating the first load balancing configuration and the second load balancing configuration comprises:
generating an updated second load balancing configuration such that, following the change, each execution instance of one or more of the plurality of software functions is subject to the same load balancing configuration as each instance of one or more of the plurality of software containers with which the one or more of the plurality of software functions is associated.

8. The method as claimed in claim 7, wherein:
the first load balancing configuration comprises a plurality of identifiers, each of which identifies a software container of the plurality of software containers; and
generating the updated second load balancing configuration comprises:
for each of the plurality of software containers, replacing the identifier that identifies the software container with an identifier that identifies the software function with which the software container is associated.

9. The method as claimed in claim 8, wherein:
generating the updated second load balancing configuration comprises:
creating a copy of the first load balancing configuration, wherein the identifier that identifies the software container is replaced in the copy of the first load balancing configuration.

10. The method as claimed in claim 8, the method comprising:
for each of the plurality of software functions, acquiring the identifier that identifies the software function.

11. The method as claimed in claim 7, the method comprising:
providing the updated second load balancing configuration to a FaaS node, wherein the FaaS node is a node that is configured to perform load balancing in the FaaS system.

12. The method as claimed in claim 7, the method comprising:
acquiring the first load balancing configuration from a CaaS node, wherein the CaaS node is a node that is configured to perform load balancing in the CaaS system.

13. The method as claimed in claim 12, wherein acquiring the first load balancing configuration from the CaaS node comprises:
reading the first load balancing configuration from the CaaS node; or
receiving the first load balancing configuration from the CaaS node in response to a request for the first load balancing configuration.

14. The method as claimed in claim 1, wherein:
in response to a change in the second load balancing configuration, coordinating the first load balancing configuration and the second load balancing configuration comprises:
generating an updated first load balancing configuration such that, following the change, each execution instance of one or more of the plurality of software function is subject to the same load balancing configuration as each instance of one or more of the plurality of software containers with which the one or more of the plurality of software functions is associated.

15. The method as claimed in claim 14, wherein:
the second load balancing configuration comprises a plurality of identifiers, each of which identifies a software function of the plurality of software functions; and
generating the updated first load balancing configuration comprises:
for each of the plurality of software functions, replacing the identifier that identifies the software function with an identifier that identifies the software container with which the software function is associated.

16. The method as claimed in claim 15, wherein:
generating the updated first load balancing configuration comprises:
creating a copy of the second load balancing configuration, wherein the identifier that identifies the software function is replaced in the copy of the second load balancing configuration.

17. The method as claimed in claim 15, the method comprising:
for each of the plurality of software containers, acquiring the identifier that identifies the software container.

18. The method as claimed in claim 14, the method comprising:
providing the updated first load balancing configuration to a CaaS node, wherein the CaaS node is a node that is configured to perform load balancing in the CaaS system.

19. The method as claimed in claim 14, the method comprising:
acquiring the second load balancing configuration from a FaaS node, wherein the FaaS node is a node that is configured to perform load balancing in the FaaS system.

20. The method as claimed in claim 19, wherein acquiring the second load balancing configuration from the FaaS node comprises:
reading the second load balancing configuration from the FaaS node; or
receiving the second load balancing configuration from the FaaS node in response to a request for the second load balancing configuration, wherein the first load balancing configuration and/or the second load balancing configuration is stored in a look-up table.

21-27. (canceled)
